(19) United States
(12) Patent Application Publication
(10) Pub. No.: US 2010/0294382 A1
(43) Pub. Date: Nov. 25, 2010

(54) CHECK DEVICE AND CHECK VALVE HAVING THE CHECK DEVICE THEREIN

(75) Inventor: Yu-Hung Su, Changhua County (TW)

Correspondence Address: APEX JURIS, PLLC, 12733 LAKE CITY WAY NORTHEAST, SEATTLE, WA, 98125, US

(73) Assignee: REBECCA LIN INTERNATIONAL CORP., Taichung (TW)

(21) Appl. No.: 12/850,049

(22) Filed: Aug. 4, 2010

(30) Foreign Application Priority Data
May 3, 2005 (TW) 99208167

(51) Int. Cl. F16K 15/00; F16K 27/00

(52) U.S. Cl. 137/528; 251/366

(57) ABSTRACT

The present invention provides a check device and a check valve equipped with the check device. The check device is made of a hard plastic with slight flexibility to be mounted in a check valve with an annular wall and an opening. The check device has a separating rib, an inner plate and an outer plate on opposite ends of the separating rib. The inner plate has several bores and a first contact face to touch a side of the wall, and the outer plate has a first contact face to touch an opposite side of the wall. A flow is cut off when the first contact face of the inner plate presses the first side of the wall, and a flow runs through the check device when a second contact of the outer plate presses a second side of the wall of the base.

### BACKGROUND OF THE INVENTION

1. Field of the Invention

The present invention relates generally to a control device for regulating flow, and more particularly to a check device and a check valve equipped with the check device therein.

2. Description of the Related Art

Typically, valves are incorporated in pipes to regulate flow by opening, closing or partially obstructing passageways therein. Some valves are incorporated in faucets for shower to mix hot water and cold water and prevent hot water from going to the cold water pipe or cold water from going to the hot water pipe.

FIG. 1 shows a check device 1 equipped in a check valve. The check device 1 is installed in a threaded barrel 2 and keeps a gap therebetween. A spring 3 urges the check device 1 against a rim 2a of the threaded barrel 2. The check valve has an outlet side S1 and an inlet side S2. The check device 1 is moved to obstruct the inlet side S2 when a water pressure in the outlet side S1 is greater than a water pressure in the inlet side S2 to cut the flow off, and the check device 1 is moved toward the outlet side S1 and compresses the spring 3 when a water pressure in the inlet side S2 is greater than a water pressure in the outlet side S1 that water may flow through the check valve.

The conventional check valve may allow water to flow through it in only one direction. The check device 1 is urged by the spring 3 to press the rim 2a of the threaded barrel 2 only when the water pressure at the outlet side S1 is greater than the water pressure at the inlet side S2. The spring 3 gets fatigue because of repetitive compression that the check device 1 can't tightly obstruct an inlet 2b that water may flow to another pipe instead of the faucet.

FIG. 2 shows an application of another conventional check valve. The check valve has a check device 4 therein. The check device 4 has a T-shaped plastic member with a cover member 4a and a T-shaped post 4b on a bottom of the cover member 4a. The post 4b of the check device 4 passes through an opening 5a of an inlet base 5 from a top thereof. The post 4b has a rim 4c with a diameter slightly greater than the opening 5a. The rim 4c is squeezed through the opening 5a with the post 4b to secure the check device 4 on the inlet base 5. The cover member 4a is flexible and is attached on a top 5b of the inlet base 5. The cover member 4a obstructs inlets 5c around the opening 5a to cut water flow off when a water pressure at an outlet side S1 is greater than a pressure at an inlet side S2. A margin of the cover member 4a is bent upward to expose the inlets 5c to pass water flow when a water pressure at the inlet side S2 is greater than a pressure at the outlet side S1.

It is obvious that a proximal end of the post 4b will be broken when water flow from the inlet side S2 with a great pressure impacts the cover member 4a repeatedly that the cover member 4a does not obstruct inlets 5c anymore.

### SUMMARY OF THE INVENTION

The primary objective of the present invention is to provide a check device, which moves steadily to cut flow off.

The secondary objective of the present invention is to provide a check valve equipped with the check device, which accurately regulates flow.

According to the objectives of the present invention, a check device of the present invention is mounted in a check valve. The check valve has a base with an annular wall with a first side and a second side opposite to the first side and an opening at a center of the wall. The check device is made of a hard plastic with slight flexibility having a separating rib, an inner plate, and an outer plate. The inner plate and the outer plate are connected to opposite ends of the separating rib. The separating rib is received in the opening of the base. The inner plate has an outer face and a first contact face opposite to the outer face that the first contact face faces the first side of the wall of the base. The outer plate has an outer face and a first contact face opposite to the outer face that the first contact face faces the first side of the wall of the base. The outer plate has a plurality of bores. A flow is cut off when the first contact face of the inner plate presses the first side of the wall, and a flow runs through the check device when a second contact face of the outer plate presses the second side of the wall of the base.

In an embodiment, the check device is provided with a reinforced plate on the inner ring. A diameter of the reinforced plate is identical to the opening of the base to protect the inner plate from being damaged by shear force.

### BRIEF DESCRIPTION OF THE DRAWINGS

FIG. 1 is a sectional view of the first conventional check valve;

FIG. 2 is a sectional view of the second conventional check valve;

FIG. 3 is a perspective view of the check device of a preferred embodiment of the present invention incorporated in the check valve;

FIG. 4 is a partial sectional view of FIG. 3;

FIG. 5 is an exploded view of FIG. 3;

FIG. 6 and FIG. 7 are perspective views of the check device of the preferred embodiment of the present invention;

FIG. 8 is a sectional view of FIG. 3, showing the check device cutting the path off between the outlet side and the inlet side;

FIG. 9 is similar to FIG. 8, showing the check device not cutting the path off between the outlet side and the inlet side; and

FIG. 10 is a perspective view of the check device of another preferred embodiment of the present invention.

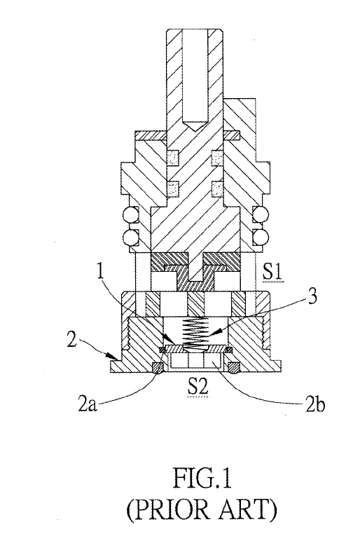

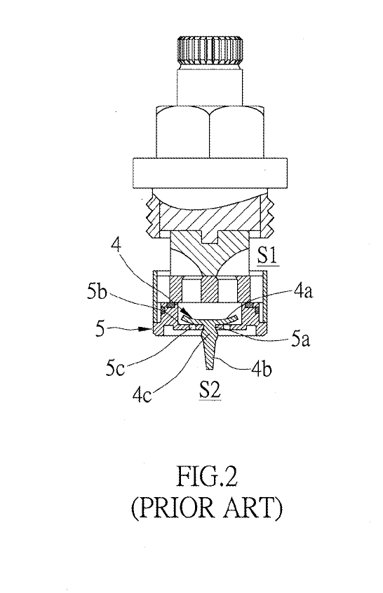

### DETAILED DESCRIPTION OF THE INVENTION

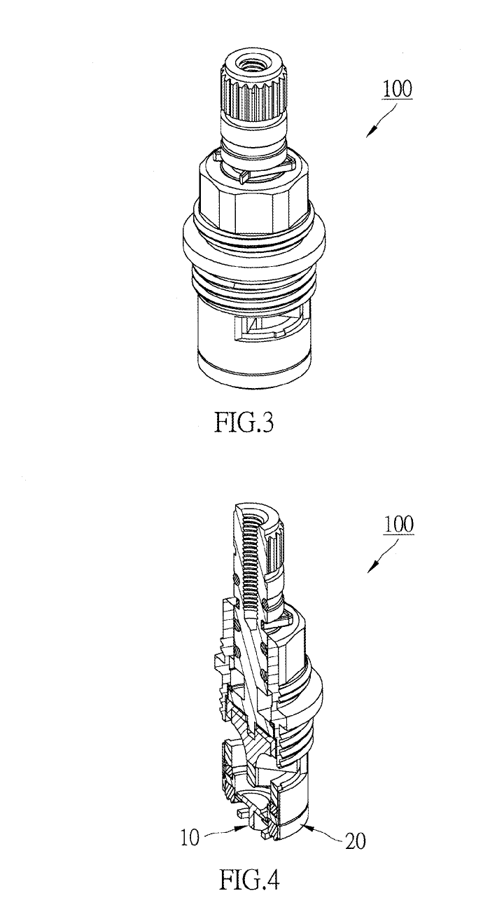

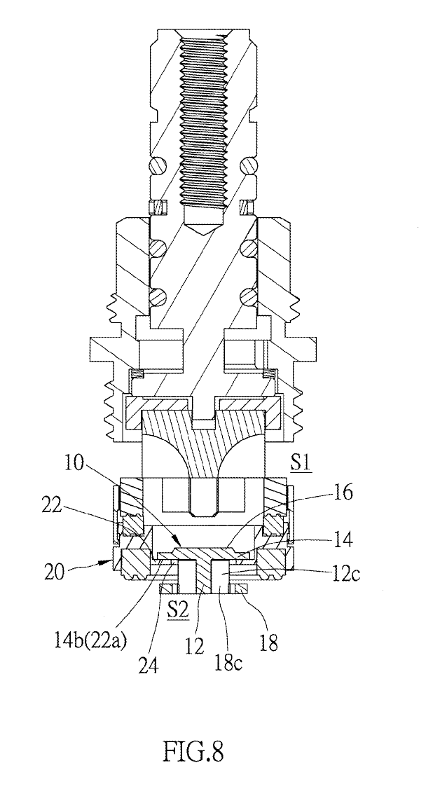

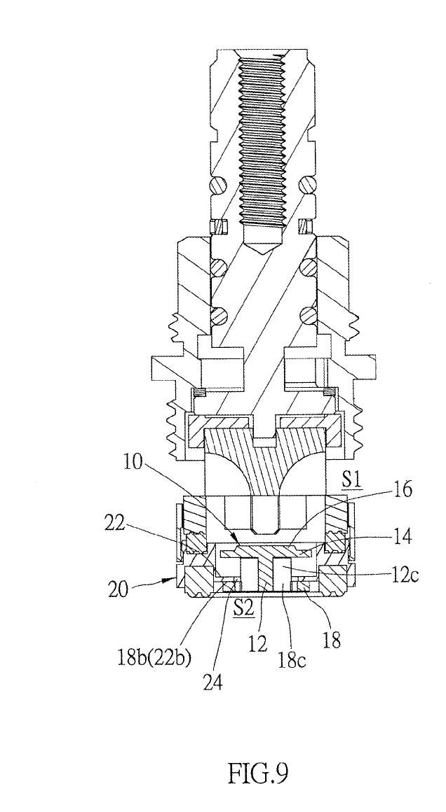

As shown in FIG. 3 to FIG. 5, a check device 10 of the preferred embodiment of the present invention is incorporated in a check valve 100. The check valve 100 is mounted in a pipe (not shown). In the present invention, the check device 10 is mounted in a hollow base 20 on a path of flow. As shown in FIG. 8, the path is divided by the check device 10 into two parts, an outlet side S1 and an inlet side S2.

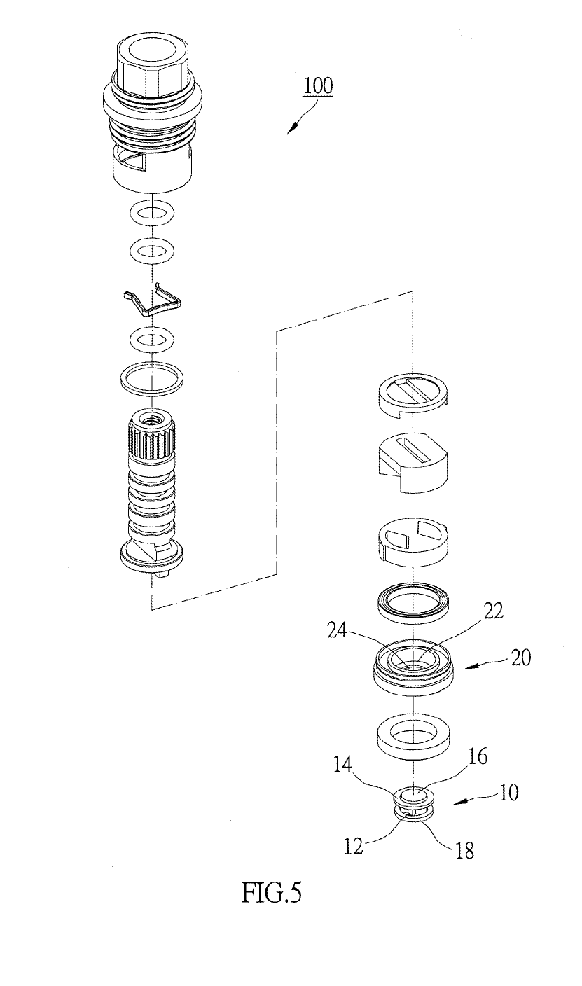

As shown in FIG. 5 and FIG. 8, the base 20 has an annular wall 22 projected from an inner side thereof to form an opening 24 at a center thereof. The annular wall 22 has a first side 22a and a second side 22b, wherein the first side 22a is at the outlet side S1 and the second side 22b is at the inlet side S2.

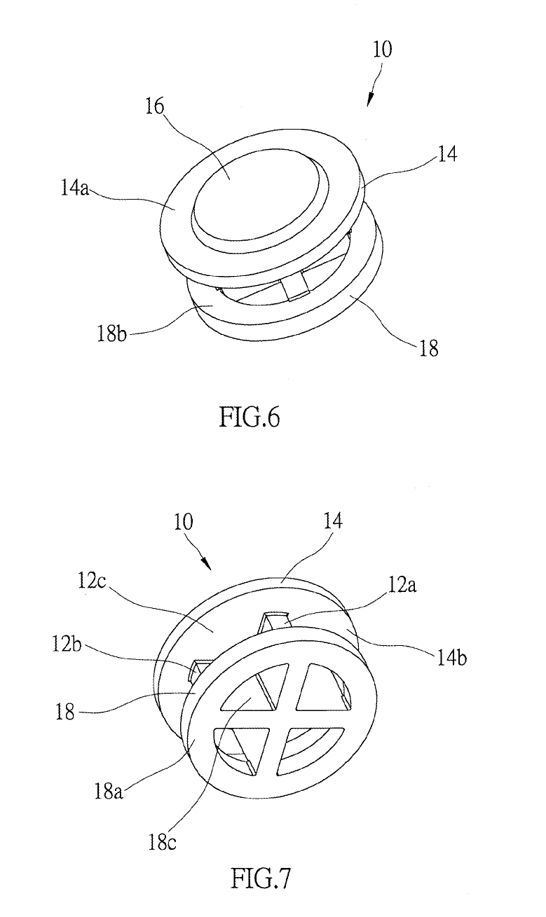

The check device 10 is a single element made of a hard plastic with slight flexibility having a separating rib 12, an inner plate 14, a reinforced plate 16, an outer plate 18, as shown in FIG. 6 and FIG. 7.

The separating rib 12 is a cross post formed by two perpendicularly crossed ribs 12a and 12b. The separating rib 12 has four sectorial slots 12c between the ribs 12a and 12b. The separating rib 12 is received in the opening 24 when the check device 10 is installed in the base 20. A height of the separating rib 12 is greater than a thickness of the wall 22.

The inner plate 14 is greater than the opening 24 of the base 20. The inner plate 14 is connected to an end of the separating rib 12. The inner plate 14 has an outer face 14a and a first contact face 14b, on which the separating rib 12 is connected to. The first contact face 14b of the inner plate 14 is in association with the first side 22a of the wall 22.

The reinforced plate 16 is a round disk on a center of the outer face 14a of the inner plate 14. The reinforced plate 16 and the inner plate 14 are made as a single element. A diameter of the reinforced plate 16 is preferred in a range between a diameter of the inner plate 14 and the opening 24. In the present embodiment, the diameter of the reinforced plate 16 is identical to the opening 24.

The outer plate 18 is greater than the opening 24 of the base 20. The outer plate 18 is connected to an opposite end of the separating rib 12 and is parallel to the inner plate 14. The outer plate 18 has an outer face 18a, a second contact face 18b, on which the separating rib 12 is connected to, and four bores 18c communicated with the slots 12c of the separating rib 12 respectively. The second contact face 18b of the inner plate 14 is in association with the second side 22b of the wall 22.

Above are the elements and structure of the check device 10 of the present invention, and the operation is described hereunder:

As shown in FIG. 8, the first contact face 14b of the inner plate 14 presses the first side 22a of the wall 22 to cut water flow off when a water pressure at the outlet side S1 is greater than a water pressure at the inlet side S2. In this condition, hot water and cold water will not flow to their relative pipes.

As shown in FIG. 9, the check device 10 is moved toward the inlet side S2 and the second contact face 18b of the outer plate 18 presses the second side 22b of the wall 22 when a water pressure at the inlet side S2 is greater than a water pressure at the outlet side S1. In this condition, water of the inlet side S2 flows through the check device 10 via the bores 18c and the slots 12c to the outlet side S1.

Therefore, the separating rib 12 makes the check device 10 moving steadily to overcome the problem of the conventional devices. Besides, the check device 10 is made of a hard plastic with a slight flexibility that high pressure at the outlet side S1 or the inlet side S2 may tightly press the first contact face 14b of the inner plate 14 on the first side 22b of the wall 22 or tightly press the second contact face 18b of the outer plate 18 on the second side 22b of the wall 22. Especially when the first contact face 14b of the inner plate 14 presses the first side 22a of the wall 22, it may accurately obstruct the opening 24 and cut the flow off. The reinforced plate 16 may increase the rigidity of the inner plate 14 with the diameter identical to the opening that the check device 10 of the present invention will regularly function even when there is a very high pressure at the outlet side S1.

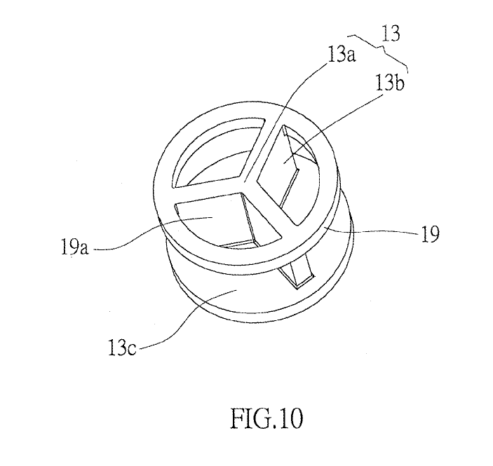

At last, the separating rib 12 is a cross in the present embodiment to connect the inner plate 14 and the outer plate 18. FIG. 10 shows another separating rib 13 with three ribs 13b projected outwardly from a center 13a. Angles between the ribs 13b are 120 degrees. There are three slots 13c between the ribs 13b. An outer plate 19 has three bores 19a communicated with the slots 13c respectively. The separating rib 13 serves the same function as usual.

The description above is a few preferred embodiments of the present invention and the equivalence of the present invention is still in the scope of claim construction of the present invention.

What is claimed is:

1. A check device, which is mounted in a base with an annular wall with a first side and a second side opposite to the first side and an opening at a center of the wall, comprising:
a separating rib received in the opening of the base;
an inner plate, which is connected to an end of the separating rib, having an outer face and a first contact face opposite to the outer face that the first contact face faces the first side of the wall of the base; and
an outer plate, which is connected to an end of the separating rib opposite to the inner plate, having an outer face and a second contact face opposite to the outer face that the second contact face faces the second side of the wall of the base, wherein the outer plate has a plurality of bores;
wherein a flow is cut off when the first contact face of the inner plate presses the first side of the wall, and a flow runs through the check device when the second contact face of the outer plate presses the second side of the wall of the base.

2. The check device as defined in claim 1, further comprising a reinforced plate on the outer face of the inner plate.

3. The check device as defined in claim 2, wherein a diameter of the reinforced plate is identical to the opening of the base.

4. The check device as defined in claim 2, wherein the reinforced plate and the inner plate are made as a single element.

5. The check device as defined in claim 1, wherein the separating rib has two crossed ribs and slots between the ribs to be communicated with the bores of the outer plate respectively.

6. The check device as defined in claim 5, wherein the ribs are substantially perpendicular to each other.

7. The check device as defined in claim 1, wherein the separating rib has three ribs projected outwardly from a center and slots between the ribs to be communicated with the bores of the outer plate respectively.

8. The check device as defined in claim 1, wherein the separating rib, the inner plate and the outer plate are made as a single element.

9. The check device as defined in claim 8, wherein the separating rib, the inner plate and the outer plate are made of a hard plastic with slight flexibility.

10. A check valve, which is mounted at a pipe to divide the pipe into an outlet side and an inlet side to regulate a flow in the pipe only from the inlet side to the outlet side, comprising:
a hollow base having a wall projected from an inner side thereof and an opening at a center of the wall, wherein the wall has a first side and a second side opposite to the first side;
a check device mounted in the base for free movement along the opening having an inner plate and an outer plate, wherein a distance between the inner plate and the outer plate is greater than a thickness of the wall of the base, and the inner plate has a first contact face facing the first side of the wall and the outer plate has a second contact face facing the second side of the wall and a plurality of bores;
wherein the first contact face of the inner plate presses the first side of the wall to cut a flow off when a flow pressure at the outlet side is greater than a flow pressure at the inlet side, and the second contact face of the outer plate presses the second side of the wall of the base to pass a flow through the check device from the inlet side to the outlet side when a flow pressure at the inlet side is greater than a flow pressure at the outlet side.

11. The check valve as defined in claim 10, wherein the check device further includes a separating rib, and the inner plate and the outer plate are connected to opposite ends of the separating rib respectively.

12. The check valve as defined in claim 11, wherein the outer plate has an outer face opposite to the second contact face and the bores are open at the outer face and the second contact face, and the separating rib has two crossed ribs and slots between the ribs to be communicated with the bores of the outer plate respectively.

13. The check valve as defined in claim 10, further comprising a reinforced plate, wherein the inner plate has an outer face opposite to the first contact face and the reinforced plate is provided on the outer face of the inner plate.

14. The check valve as defined in claim 13, wherein a diameter of the reinforced plate is identical to the opening of the base.

15. The check valve as defined in claim 14, wherein the reinforced plate and the inner plate are made as a single element.
